(19) United States
(12) Patent Application Publication
(10) Pub. No.: US 2025/0323479 A1
(43) Pub. Date: Oct. 16, 2025

(54) COMBINED MOUNTING ASSEMBLIES OF ELECTRICAL BOXES AND COMMUNICATION CABLE BRACKETS AND METHODS OF ASSEMBLING SAME

(71) Applicant: ABB Schweiz AG, Baden (CH)

(72) Inventors: Daniel Lalancette, Saint-Jean Sur Richelieu (CA); Raphael Beaudin Lavigne, Saint-Jean-Sur-Richelieu (CA); Camille Bizier-Lavery, Saint-Jean-Sur-Richelieu (CA); Marc-Antoine Veillette, Saint-Jean-Sur-Richelieu (CA)

(21) Appl. No.: 19/098,841

(22) Filed: Apr. 2, 2025

(30) Foreign Application Priority Data
Apr. 16, 2024 (CA) 3235286

(51) Int. Cl. H02G 3/08; H02G 3/04; H02G 3/12

(52) U.S. Cl. CPC H02G 3/081; H02G 3/0456; H02G 3/126

(57) ABSTRACT

A combined mounting assembly for providing electrical connections with electrical utility and/or communication cables is provided. The combined mounting assembly includes an electrical box configured to provide electrical connections to electrical utility, a connection plate shaped to be mounted on a stud of a building, and a cable bracket configured to provide electrical connections with communication cables. The connection plate is positioned between and coupled with the electrical box and the cable bracket.

### BACKGROUND

The field of the disclosure relates generally to electrical power delivery, and more particularly, to mounting assemblies for providing electrical connections.

In a building, electrical connections to power utility and/or communication cables are needed. The connection to power utility is provided through an electrical box, while the connection to communication cables is provided at an outlet for communication cables. A design of a building often requires the outlet for communication and the electrical box for power to be located adjacent to one another for the ease of installation and maintenance and to be aligned with one another for aesthetics of the building. Known mounting assemblies are disadvantaged in some aspects and improvements are desired.

### BRIEF DESCRIPTION

In one aspect, a combined mounting assembly for providing electrical connections with electrical utility and/or communication cables is provided. The combined mounting assembly includes an electrical box configured to provide electrical connections to electrical utility, a connection plate shaped to be mounted on a stud of a building, and a cable bracket configured to provide electrical connections with communication cables. The connection plate is positioned between and coupled with the electrical box and the cable bracket.

In another aspect, a method of assembling a combined mounting assembly for providing electrical connections with electrical utility and/or communication cables is provided. The method includes forming a connection plate shaped to be mounted on a stud of a building and forming a cable bracket configured to provide electrical connections with communication cables. The method also includes coupling the connection plate with the cable bracket and an electrical box with the connection plate being positioned between the cable bracket and the electrical box.

### BRIEF DESCRIPTION OF DRAWINGS

These and other features, aspects, and advantages of the present disclosure will become better understood when the following detailed description is read with reference to the accompanying drawings in which like characters represent like parts throughout the drawings.

FIG. 1A shows a known mounting assembly for power and communication connections.

FIG. 1B is a perspective view of another known mounting assembly for power and communication connections.

FIG. 2A is a perspective view of an example combined mounting assembly being installed on a stud.

FIG. 2B is a top view of the assembly shown in FIG. 2A.

FIG. 2C is a side view of the assembly shown in FIG. 2A.

FIG. 2D is a rear view of the assembly shown in FIG. 2A.

FIG. 2E is a front view of the assembly shown in FIG. 2A.

FIG. 3A is a top perspective of the mounting assembly shown in FIG. 2A, where the cable holder of the mounting assembly is in a folded position.

FIG. 3B is a bottom perspective of the mounting assembly shown in FIG. 3A.

FIG. 3C is a top perspective of the mounting assembly in FIG. 3A when the cable holder is in an unfolded position.

FIG. 3D is a bottom perspective view of the mounting assembly shown in FIG. 3C.

FIG. 4A is a top perspective view of a bracket assembly of the mounting assembly shown in FIG. 3A.

FIG. 4B is a bottom perspective view of the bracket assembly shown in FIG. 4A.

FIG. 4C is a top perspective of the bracket assembly shown in FIG. 4A when the cable holder in an unfolded position.

FIG. 4D is a bottom perspective of the bracket assembly shown in FIG. 4C.

FIG. 5A is a perspective view of another example combined mounting assembly.

FIG. 5B is a top view of the mounting assembly shown in FIG. 5A.

FIG. 5C is a front view of the mounting assembly shown in FIG. 5A.

FIG. 5D is a right side view of the mounting assembly shown in FIG. 5A.

FIG. 6 is a flow chart of an example method of assembling mounting assemblies shown in FIGS. 2A-5D.

### DETAILED DESCRIPTION

The disclosure includes combined mounting assemblies and methods of assembling mounting assemblies. Method aspects will be in part apparent and in part explicitly discussed in the following description.

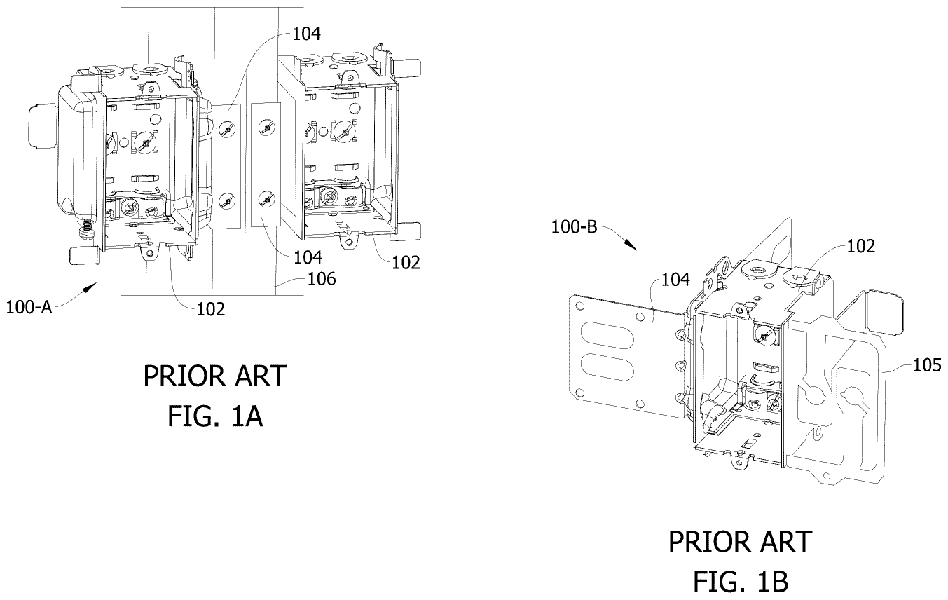

FIGS. 1A and 1B show known mounting assemblies 100-A, 100-B for providing electrical connections with power utility and communication cables. Power utility supplies electrical power to the building through electrical connections provided by an electrical box. Communication cables are used to provide communication to the building, such as Internet or coaxial cables, through electrical connections with communication cables.

Electrical boxes and cable brackets are typically fabricated and/or installed by different entities. For example, an electrical box may be provided by an electrical power company, and an electrician installs the utility box. A cable bracket or outlet may be provided by a communication company, and a field worker from the communication company handles the communication cables. A cable bracket is often unavailable to an electrician. As a result, an electrical box 102 may be used in the place of a cable bracket (see FIG. 1A), where two electrical boxes 102 are used, with one providing electrical connections to power utility and the other adapted to provide electrical connections to communication cables.

The voltage of current flowing through the communication cables are typically much lower than the voltage of current flowing through the utility lines. For the safety of the field workers and to accommodate the two groups of field workers, a design of a building often specifies that the electrical box 102 and the cable bracket (the other electrical box 102 in FIG. 1A) to be on separate sides of a stud 106. The design of a build also specifies that the electrical box 102 and the cable bracket should be aligned with one another, or at approximately the same height, such that field workers and/or users can readily identify the electrical box and the cable bracket, and the installation is aesthetically pleasing.

An electrical box 102 includes a mounting bracket 104. The width of the mounting bracket 104 is originally designed for installing one electrical box 102 onto the stud 106. The widths of two mounting brackets 104 are therefore too wide to fit both mounting brackets 104 onto a stud 106 at the same height. The mounting brackets 104 therefore need to be shortened before installing the electrical boxes 102 onto the stud 106. After being shortened, the mounting brackets 104 of the electrical boxes 102 also need to be aligned. Manual alignment may be challenging and labor intensive.

In at least one known mounting assembly 100-B, the cable bracket 105 and the electrical box 102 are combined. The cable bracket 105 and the electrical box 102 are positioned at the same side of a mounting bracket 104. The installation of the mounting assembly 100-B with a stud 106 tends to be unstable because of the lopsidedness of the mounting assembly 100-B when being installed on the stud 106. Further, the mounting bracket 104 may not be perpendicular with a side of the electrical box 102 such that the mounting bracket 104 is not perpendicular with a side of the stud 106, increasing the difficulty in installation.

In contrast, the assemblies and methods disclosed herein address the above problems in known mounting assemblies. The combined mounting assemblies disclosed herein facilitate stable and aligned installations of electrical boxes and cable brackets. The combined mounting assembly includes both an electrical box and a cable bracket. When the mounting assembly is installed onto a stud, the electrical box and the cable bracket are positioned at opposite sides of the stud, avoiding confusion and providing increased safety to field workers and/or users and increased stability of the installation. The electrical box and the cable bracket are aligned without a need of manual alignment, increasing the case of installation and reducing the costs of labor. The time for installation is further reduced, where, instead of installing two electrical boxes, installation of only one combined mounting assembly is needed. The assemblies and methods disclosed herein meet the long-felt need from customers in aligned, separately-positioned electrical boxes and cable brackets in mounting assemblies, which have not been met partially because electrical boxes and cable brackets are often in different markets and serviced by different providers. The combined mounting assemblies disclosed herein are fabricated using an embossing mechanism and include embossed features to increase the strength of the mounting assemblies while facilitating reduced thickness of the material for fabricating the mounting assemblies, thereby reducing the material costs of the mounting assemblies and/or increasing the strength of the mounting assemblies and the durability of the installation.

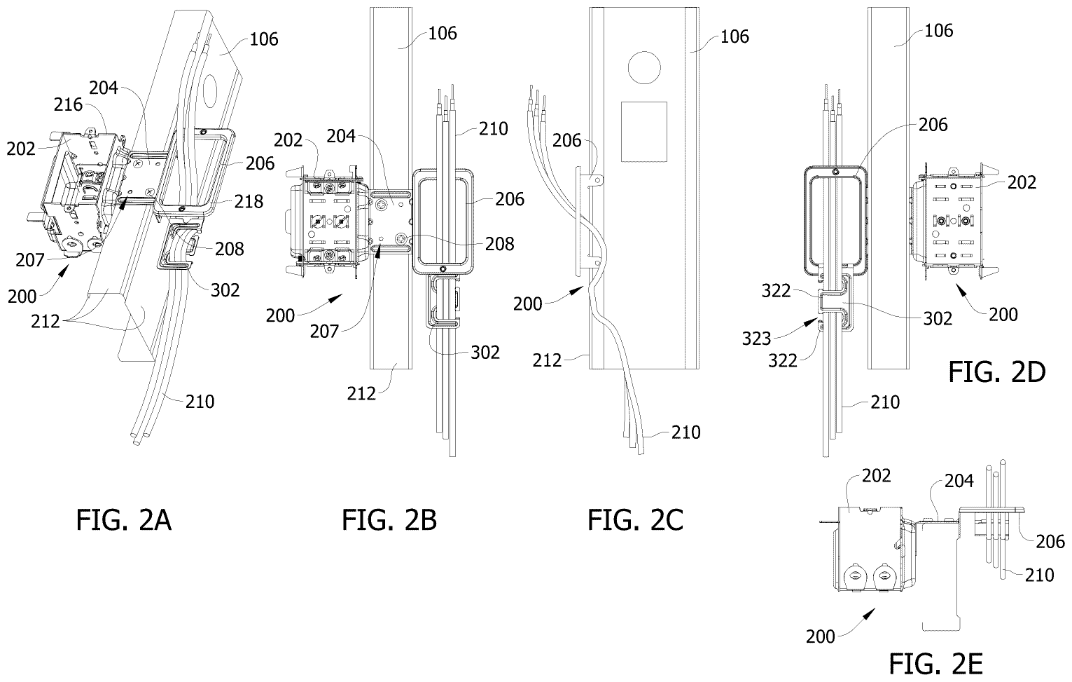

FIGS. 2A-2E show an example combined mounting assembly 200 installed on a stud 106. FIG. 2A is a perspective view of the mounting assembly 200 installed on the stud 106. FIG. 2B is a top view of the assembly shown in FIG. 2A. FIG. 2C is a right side view of the assembly shown in FIG. 2A. FIG. 2D is a rear view of the assembly shown in FIG. 2A. FIG. 2E is a front view of the assembly shown in FIG. 2A.

In the example embodiment, the mounting assembly 200 includes an electrical box 202, a connection plate 204, and a cable bracket 206. The electrical box 202 is configured to provide electrical connections to electrical utility. The cable bracket is configured to provide electrical connections with communication cables 210. The connection plate 204 is shaped to be mounted on a stud 106 of a building. The stud 106 may be metallic or wooden. The connection plate 204 defines one or more plate apertures 207 each sized to receive a fastener 208 therethrough. The connection plate 204 is positioned between and coupled with the electrical box 202 and the cable bracket 206. The connection plate 204 and the cable bracket 206 may be formed as one single unit. Alternatively, the connection plate 204 and the cable bracket 206 are separate pieces and are coupled to one another via coupling mechanisms such as welding or fastening with fasteners. The connection plate 204 is coupled with the electrical box 202 via welding. Other methods may be used to couple the connection plate 204 with the electrical box 202, such as using fasteners like rivets. In some embodiments, the entire mounting assembly 200 is formed as one single unit. For example, the entire mounting assembly 200 may be formed from one piece of sheet metal and the connection plate 204 extends from the electrical box and the cable bracket such that additional coupling of the connection plate 204 with the electrical box 202 and/or the cable bracket 206 is not needed.

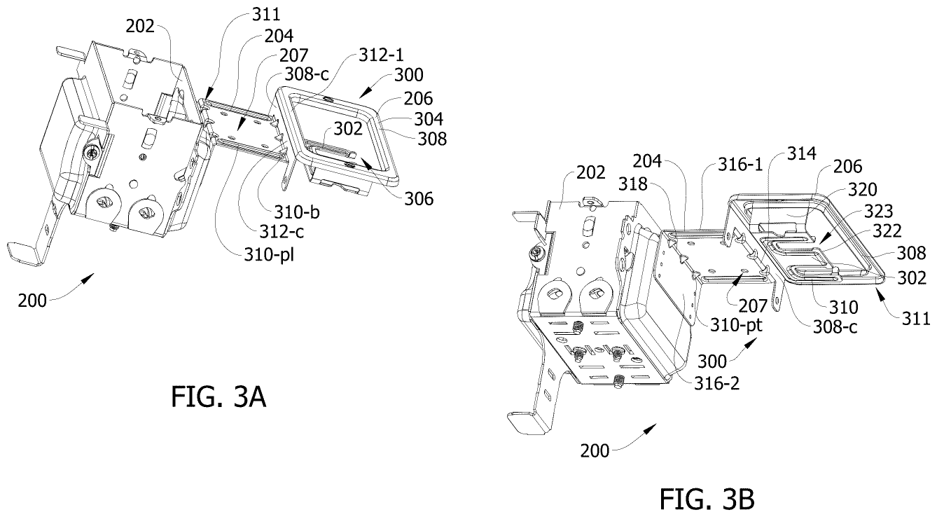

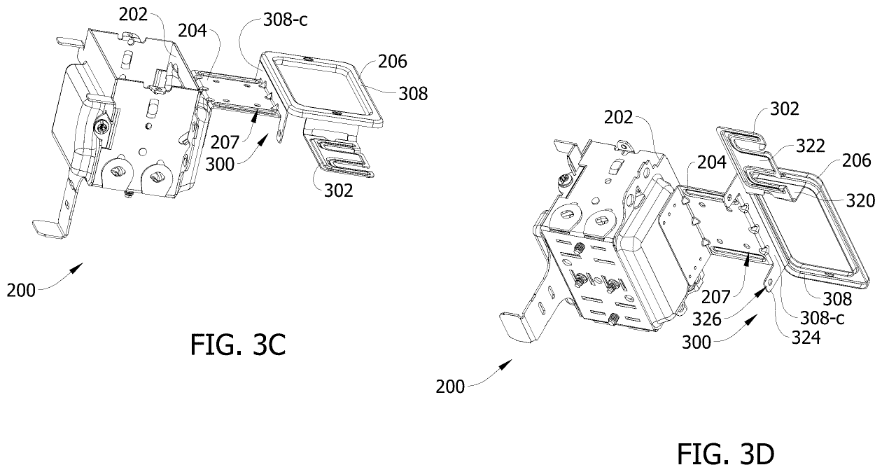

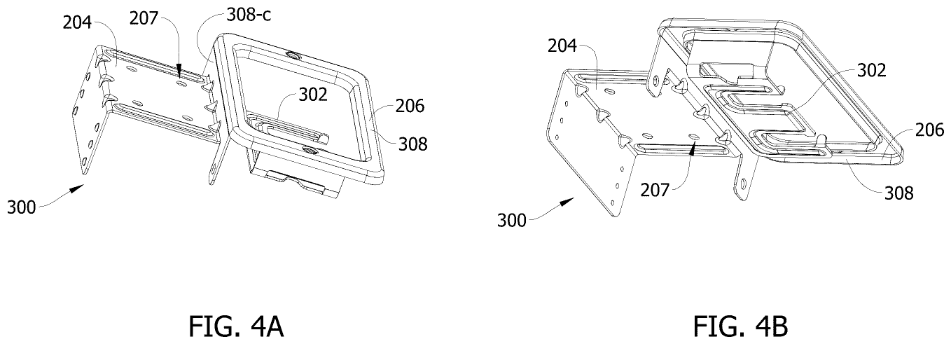

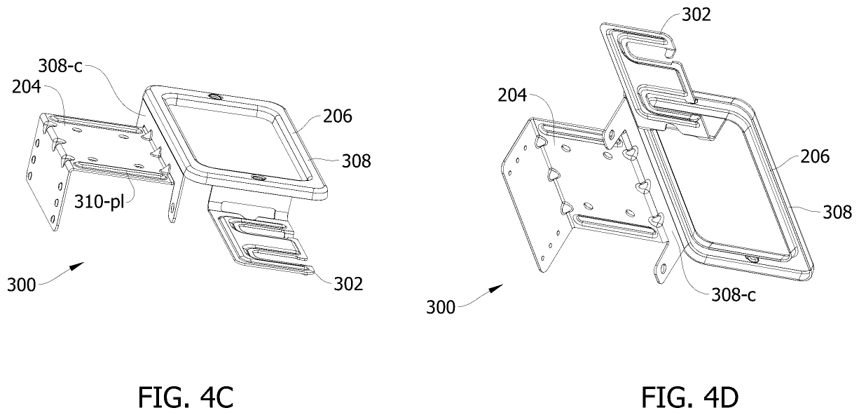

FIGS. 3A-3D show the mounting assembly 200 by itself. FIGS. 4A-4D show a bracket assembly 300 of the mounting assembly 200 by itself. FIGS. 3A and 3B are the top and bottom perspective views of the mounting assembly 200 and FIGS. 4A and 4B are the top and bottom perspective views of the bracket assembly 300, when a cable holder 302 of the cable bracket 206 is in a folded position. FIGS. 3C and 3D are the top and bottom perspective views of the mounting assembly 200 and FIGS. 4C and 4D are the top and bottom perspective views of the bracket assembly 300, when the cable holder is in an unfolded position.

In the example embodiment, the bracket assembly 300 includes the connection plate 204 and the cable bracket 206. The cable bracket 206 includes a frame 304. The frame 304 may be in a shape of a rectangle. The frame 304 may be in other shapes, such as a polygon, that enable the frame 304 to function as described herein. The frame 304 defines a frame aperture 306. Communication cables 210 may be retrieved through the frame aperture 306 in building connections for communication (see FIGS. 2A-2E). The frame 304 includes one or more sides 308. The sides 308 form the shape of the frame 304. One of the sides 308 may be a connection side 308-c that connects the cable bracket 206 with the connection plate 204. The connection side 308-c may include a first surface 312-1 and a connection surface 312-c extending at a non-zero angle with the first surface 312-1. The connection side 308-c and the connection plate 204 intersect at a bracket edge 314. The connection side 308-c may further include one or more legs 324. The legs 324 are positioned at the ends of the connection side 308-c. A leg aperture 326 is defined in a leg 324 and sized to receive a fastener 208 to fasten the leg 324 with the stud 106, increasing the strength in coupling the mounting assembly 200 with the stud 106.

In the example embodiment, the cable bracket 206 includes a cable holder 302 extending from the frame 304 at one or more sides 308. The cable holder 302 is configured to hold communication cables 210 (see FIGS. 2A-2E). The cable holder 302 may be in a folded position (sec 3A, 3B, 4A, and 4B), where the cable holder 302 extends toward one or more sides 308. The cable holder 302 may be in an unfold position (sec FIGS. 2A-2E, 3C, 3D, 4C, and 4D), where the cable holder 302 extends away from the frame 304 and the sides 308 of the frame 304. In use, the cable holder 302 may be in a folded position or an unfolded position. The cable holder 302 may be manufactured and shipped in a folded positioned.

In the example embodiment, the cable holder 302 includes an arm 320 extending from the frame 304. One or more fingers 322 extends from the arm 320. The fingers 322 define one or more elongated finger apertures 323 between neighboring fingers 322 and sized to receive one or more communication cables 210 (see FIGS. 2A-2E) therethrough. The cable holder 302 may be formed into a shape resembling letter E.

In the example embodiment, the connection plate 204 includes a first portion 316-1 and a second portion 316-2. The first portion 316-1 defines one or more plate apertures 207. The bracket assembly 300 may be coupled with the electrical box 202 at the second portion 316-2.

In the example embodiment, the angle between the second portion 316-2 and the first portion 316-1 of the connection plate 204 may be approximately 90°, where the first portion 316-1 and the second portion are approximately perpendicular with one another. The angle between the first portion 316-1 and the connection surface 312-c of the connection side 308-c may be approximately 90°, where the first portion 316-1 and the connection surface 312-c are approximately perpendicular with one another. As a result, when placed on the stud 106, the mounting assembly 200 has the second portion 316-2 and the legs 324 of the connection surface 312-c aligned along opposite faces 212 of the stud 106, thereby increasing the case in installation (see FIGS. 2A-2E). In contrast, in the known mounting assembly 100-B (see FIG. 1B), the mounting bracket 104 is not necessarily perpendicular with a side of the electrical box 102.

In the example embodiment, the mounting assembly 200 includes ridges 310 to increase the strength of the mounting assembly 200. Ridges 310 may be formed by shaping the mounting assembly 200 into the shapes of the ridges 310 or grooves 311 at the opposite side. The ridges 310 are at non-zero angles with a bending force of the ridges, thereby increasing the strength of the mounting assembly 200 and facilitating a reduced thickness for material and costs of the assembly. The mounting assembly 200 may include bracket ridges 310-b, portion ridges 310-pt, and/or plate ridges 310-pl. The bracket ridges 310-b are positioned along the bracket edge 314. The bracket ridges 310-b are at non-zero angles with the bracket edge 314. The bending of the connection plate 204 and/or the cable bracket 206 along the bracket edge 314 is resisted by the ridges 310 as the extending direction of the ridges 310 are not parallel or at non-zero angles with the bracket edge 314. The connection plate 204 may include one or more portion ridges 310-pt positioned along a portion edge 318 between the first portion 316-1 and the second portion 316-2 of the connection plate 204. The connection plate 204 is bent along the portion edge 318 between the first portion 316-1 and the second portion 316-2. The extending directions of the portion ridges 310-pt are at non-zero angles with the portion edge 318 such that the bending of the connection plate 204 is resisted by the portion ridges 310-pt. The connection plate 204 may include one or more plate ridges 310-pl in the first portion 316-1. The plate ridge 310-pl is at a non-zero angle with the bracket edge 314 and/or the portion edge 318 such that the bending of the first portion 316-1 is resisted by the plate ridge 310-pl.

In some embodiments, ridges 310 may be formed in the cable bracket 206. For example, ridges 310 may be formed in fingers 322. Grooves 311 may be formed along sides 308.

In the known mounting assemblies, stamping is used to fabricate the mounting assemblies 100-A, 100-B (see FIGS. 1A and 1B), where a sheet metal is cut, punctured, and/or bend along lines. In contrast, in the example embodiments, the mounting assembly 200 is embossed, where at least parts of the mounting assembly 200, such as the ridges 310, are fabricated using an embossing mechanism. In embossing, the shape of the original material, such as sheet metal, is changed at some locations. Grooves 311 and/or ridges 310 may be formed by embossing. The embossed ridges or grooves are at non-zero angles with bending forces of the ridges/grooves, thereby increasing the strength of the assembly and facilitating a reduced thickness of material and reduced costs of the assembly.

In some embodiments, the ridges 310 are formed by molding. The material of the connection plate 204 and/or the cable bracket 206 may be plastic.

In some embodiments, for different applications, the bracket assembly 300 may be positioned at different depths from the top edge 216 of the electrical box 102. Various depths may be used to accommodate the thickness of the dry wall such that, after the mounting assembly 200 is installed on the stud 106, the top edge 216 is flush or level with the dry wall. The depth of the bracket assembly 300 relative to the top edge 216 of the electrical box 102 is the distance or depth between the connection plate 204 and the top edge 216. The depth may be adjusted by coupling the bracket assembly 300 at the desired depth. Example depths may be ½ in. (1.27 cm), ⅝ in. (1.59 cm), 1 in. (2.54 cm), 1¼ in. (3.175 cm), and 2 in. (5.08 cm).

Referring back to FIGS. 2A-2E, in operation, to install the mounting assembly 200 onto the stud 106, the first portion 316-1 is positioned over a face 212 of the stud 106 with the electrical box 202 and the cable bracket 206 at either side of the stud 106. Fasteners 208 are inserted into the plate apertures 207 and fasten the first portion 316-1 with the stud 106. Communication cables 210 may be positioned in and held by the cable holder 302 such that the field worker does not need to fumble behind the frame 304 and/or the dry wall (not shown) to retrieve the communication cables 210, which may be challenging because the size of the frame aperture 306 provided by the frame 304 is limited.

The strength of coupling the mounting assembly 200 with the stud 106 is increased by positioning the electrical box 202 and the cable bracket 206 at the opposite sides as forces acting on the coupling point are from both sides of the coupling point. Besides increasing the strength of coupling with the stud 106, the electrical box 202 and the cable bracket 206 being installed on separate sides of the stud 106 increase the convenience for the field workers and/or users. The safety of the installation is also increased because the cable bracket 206 for a relatively low voltage is separated from the electrical box 202 for a relatively high voltage. Because the electrical box 202 and the cable bracket 206 are aligned with one another during fabrication, aligning the electrical box 202 with the cable bracket 206 is no longer needed in installing the electrical box 202 and the cable bracket 206 onto the stud 106.

The mounting assembly 200 may be directly mounted onto a stud 106, unlike in known mounting assembly 100-A, where the mounting bracket 104 may need to be shortened to provide space for installation of another electrical box 102 on the stud 106 at the same height. The mounting assembly 200 may be mounted on the stud 106 as one unit. The speed and convenience of installation is increased, where fastening the mounting assembly 200 installs both the electrical box 202 and the cable bracket 206 onto the stud 106, unlike separate installations are needed, besides cutting the brackets and aligning the two electrical boxes 202.

In some embodiments, the connection plate 204 is perpendicular or at a right angle with the sides of the electrical box 202 and the connection surface 312-c such that the electrical box 202 and the legs 324 of the connection surface 312-c align with faces 212 of the stud 106 and the connection plate 204 or at least a portion of the connection plate 204 aligns with another face 212 of the stud 106, thereby increasing the convenience and the strength of the coupling of the mounting assembly 200 with the stud 106. In addition, the top edge 216 of the electrical box 202 and the top face 218 of the cable bracket 206 are flush with one another or at approximately the same level such that the cover (not shown) of the electrical box 202 and the cover (not shown) of the frame 304 may be positioned on the dry wall after mounting assembly 200 is installed on the stud 106.

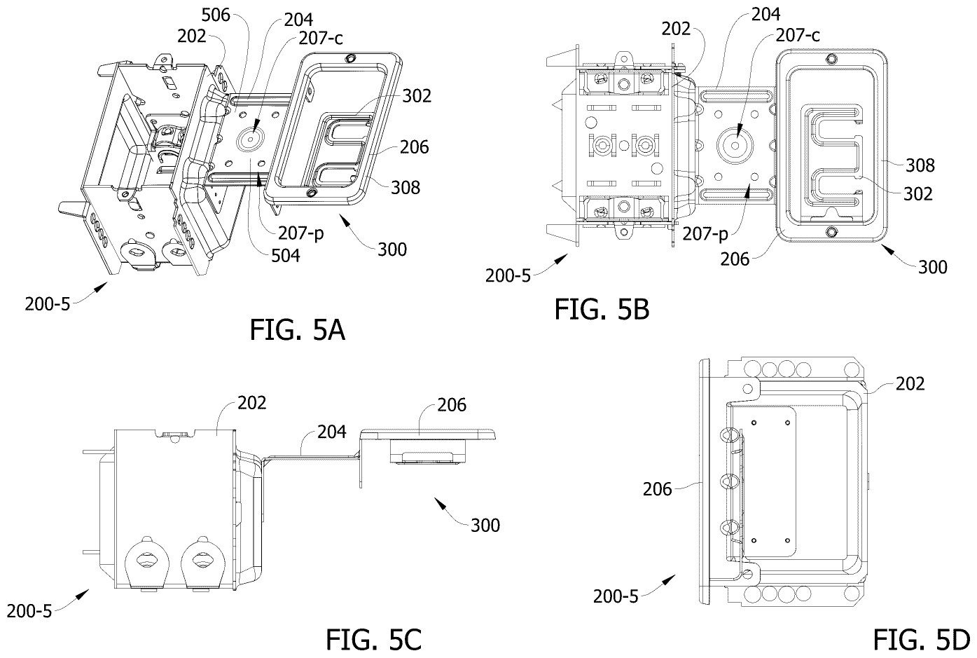

FIGS. 5A-5D show another example mounting assembly 200-5. FIG. 5A is a perspective view of the mounting assembly 200-5. FIG. 5B is a top view of the mounting assembly 200-5. FIG. 5C is a front view of the mounting assembly 200-5. FIG. 5D is a right side view of the mounting assembly 200-5. In the example embodiment, compared to the mounting assembly 200 shown in FIGS. 2A-4D, the mounting assembly 200-5 includes an aperture ridge 310. The aperture ridge 310 may be embossed. Alternatively, the aperture ridge 310 is molded. The aperture ridge 310 at least partially surrounds the plate aperture 207. The ridge 310 increases the strength of the mounting assembly 200. The connection plate 204 defines a plurality of plate apertures 207. The plate aperture 207-c may be positioned at a center area 504 of the connection plate 204. The plate apertures 207-p may be positioned at a periphery 506 of the connection plate 204. A plate aperture 207 may be positioned diagonal or leveled with another plate aperture 207 (also see FIGS. 2A-4D). The mounting assembly 200 may be installed onto a stud 106 at the peripheral plate apertures 207 (see FIGS. 2A-2D) or the center plate aperture 207-c. The center plate aperture 207-c facilitates a one-fastener installation. Fasteners 208 may be received in diagonal plate apertures 207 such that the fasteners 208 are as far apart as provided by the connection plate 204 to increase the strength of hold with the stud 106 while increasing the number of fasteners, which also increases the strength of hold.

The electrical box 202 shown in FIGS. 2A-5D are examples for illustration purposes only. Mounting assemblies 200 and bracket assemblies 300 described herein may be used with any electrical boxes.

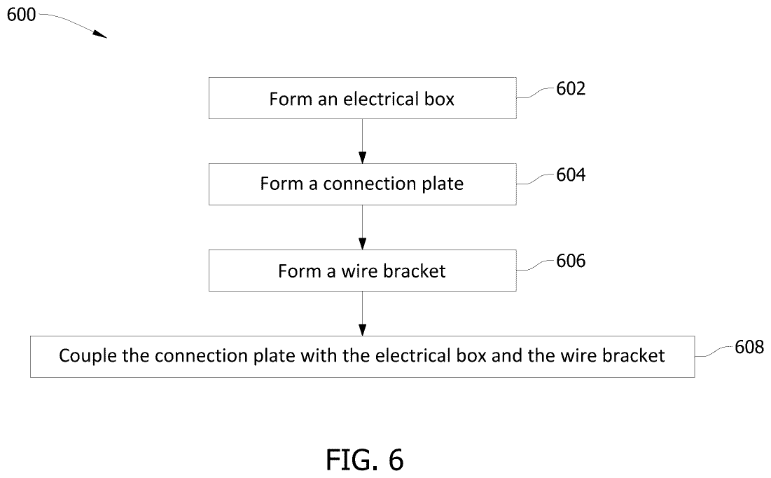

FIG. 6 is a flow chart of an example method 600 of assembling a combined mounting assembly. Mounting assemblies may be mounting assemblies 200 described herein. In the example embodiment, the method 600 includes forming 602 an electrical box. In some embodiments, the method 600 does not include forming 602 the electrical box, where the bracket assembly 300 is coupled with an electrical box 202 fabricated at a different assembly line or facility from the bracket assembly 300.

In the example embodiment, the method 600 also includes forming 604 a connection plate. Connection plates may be connection plates 204 described herein. The method 600 further includes forming 606 a cable bracket. Wire brackets may be cable brackets 206 described herein. In addition, the method 600 includes coupling 608 the connection plate with the cable bracket and the electric box with the connection plate being positioned between the cable bracket and the electrical box.

At least one technical effect of the systems and methods described herein includes (a) a combined mounting assembly for providing electrical connections of power and communication; (b) ridges in the mounting assembly to increase the strength of the mounting assembly; (c) embossed ridges; and (d) an embossing mechanism in assembling a mounting assembly.

Example embodiments of mounting assemblies and methods of assembling mounting assemblies are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A combined mounting assembly for providing electrical connections with an electrical utility and/or communication cables, the combined mounting assembly comprising:
an electrical box configured to provide the electrical connections to the electrical utility;
a connection plate shaped to be mounted on a stud of a building; and
a cable bracket configured to provide the electrical connections with the communication cables,
wherein the connection plate is positioned between and coupled with the electrical box and the cable bracket.

2. The combined mounting assembly of claim 1, further comprising one or more embossed ridges.

3. The combined mounting assembly of claim 1, further comprising a bracket edge positioned between the cable bracket and the connection plate, wherein the mounting assembly further comprises one or more bracket ridges positioned along the bracket edge.

4. The combined mounting assembly of claim 1, further comprising a bracket edge positioned between the cable bracket and the connection plate, wherein the connection plate defines one or more plate ridges positioned at non-zero angles with the bracket edge.

5. The combined mounting assembly of claim 1, wherein the connection plate comprises a first portion, a second portion, and a portion edge positioned between the first portion and the second portion, the connection plate further comprising one or more portion ridges positioned along the portion edge.

6. The combined mounting assembly of claim 1, wherein the connection plate comprises a first portion and a second portion perpendicular with the first portion, the cable bracket further comprising a connection surface connected with the connection plate, the connection surface being perpendicular with the first portion.

7. The combined mounting assembly of claim 1, wherein the connection plate defines a plate aperture sized to receive a fastener therethrough, the connection plate comprising an aperture ridge at least partially surrounding the plate aperture.

8. The combined mounting assembly of claim 1, wherein the connection plate defines a plurality of plate apertures each sized to receive a fastener therethrough.

9. The combined mounting assembly of claim 1, wherein the cable bracket and the connection plate are formed as one single unit.

10. The combined mounting assembly of claim 1, wherein the electrical box and the connection plate are aligned when the mounting assembly is mounted on the stud.

11. A method of assembling a combined mounting assembly for providing electrical connections with an electrical utility and/or communication cables, the method comprising:
forming a connection plate shaped to be mounted on a stud of a building;
forming a cable bracket configured to provide the electrical connections with the communication cables; and
coupling the connection plate with the cable bracket and an electrical box with the connection plate being positioned between the cable bracket and the electrical box.

12. The method of claim 11 further comprising:
embossing one or more ridges in the connection plate and/or the cable bracket.

13. The method of claim 11, wherein a bracket edge is positioned between the cable bracket and the connection plate, the method further comprising:
forming one or more bracket ridges along the bracket edge.

14. The method of claim 11, wherein a bracket edge is positioned between the cable bracket and the connection plate, the method further comprising:
forming one or more plate ridges in the connection plate at a non-zero angle with the bracket edge.

15. The method of claim 11, wherein the connection plate includes a first portion, a second portion, and a portion edge positioned between the first portion and the second portion, the method further comprising:
forming one or more portion ridges along the portion edge.

16. The method of claim 11, wherein:
forming the connection plate further comprises forming the connection plate into a first portion and a second portion with the second portion being perpendicular with the first portion; and
forming the cable bracket further comprises forming a connection surface of the cable bracket connected with the connection plate and being perpendicular with the first portion.

17. The method of claim 11, wherein forming the connection plate further comprises:
defining a plate aperture sized to receive a fastener therethrough; and
forming an aperture ridge at least partially surrounding the plate aperture.

18. The method of claim 11, wherein forming the connection plate further comprises:
defining a plurality of plate apertures each sized to receive a fastener therethrough.

19. The method of claim 11 further comprising:
forming the cable bracket and the connection plate as one single unit.

20. The method of claim 11, wherein coupling the connection plate further comprises:
coupling the connection plate with the electrical box at a selected depth between the connection plate and a top edge of the electrical box.
